(19) United States
(12) Patent Application Publication
(10) Pub. No.: US 2005/0190965 A1
(43) Pub. Date: Sep. 1, 2005

(54) Apparatus and method for determining anchor shots

(75) Inventors: Doosun Hwang, Seoul (KR); Sangkyun Kim, Gyeonggi-do (KR); Jiyeun Kim, Seoul (KR); Youngsu Moon, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-Si (KR)

(21) Appl. No.: 11/039,932

(22) Filed: Jan. 24, 2005

(30) Foreign Application Priority Data
Feb. 28, 2004 (KR) 2004-13778

(51) Int. Cl. G06K 9/00

(52) U.S. Cl. 382/165

(57) ABSTRACT

A method of and apparatus for determining anchor shots which can be used in indexing, summarizing, and browsing contents of video data. The method includes: extracting a plurality of basic shots from the video data according to a predetermined standard; selecting a plurality of anchor model candidate shots from the plurality of basic shots by applying a first standard to the plurality of basic shots; determining at least one anchor model shot by applying a second standard to the plurality of anchor model candidate shots; and determining at least one anchor shot by comparing the amount of similarity of the anchor model shots and the plurality of basic shots.

### CROSS-REFERENCE TO RELATED APPLICATION

This application claims the priority of Korean Patent Application No. 2004-13778, filed on Feb. 28, 2004, in the Korean Intellectual Property Office, the disclosure of which is incorporated herein in by reference.

### BACKGROUND OF THE INVENTION

1. Field of the Invention

The present invention relates to videos and, more particularly, to a method of automatically detecting anchors used for indexing, summarizing, and browsing videos of programs.

2. Description of Related Art

Various kinds of information can be obtained through mediums, such as television, Internet, and radio. In particular, a news program has a very important role as an information source in modern society. Today, however, watching a news program at a fixed time is sometimes difficult. On the other hand, since a vast amount of information can be obtained through the news or other programs, many desire to watch a previously-broadcast news program. A broadcasting station provides videos of the news and other programs and sells the videos.

Customers can view the offered data through playback devices. If customers are allowed to view only desired portions of the program rather than the entire program, indexing and browsing functions should be provided together with the program.

In general, the news program conveys various items in a sequential manner. In other words, it is common for an anchor to preliminarily announce news items and reporters convey the details of the news items while showing reference materials. Therefore, the news items can be generally distinguished from one another on the basis of the anchor.

Assuming that a snapshot of a screen on which the anchor appears in a news video is an anchor shot, the anchor shot can be used for efficiently indexing and browsing news videos. In order to obtain the anchor shot, there have been three main conventional methods: a template-based method, a clustering-based method, and a multimodal-based method.

The template-based method is disclosed in two papers entitled “Video indexing through integration of syntactic and semantic features” by M. Tekalp in 1996, and “Automatic anchor person detection from an MPEG coded TV program” by Y. Nakajima. This method has a disadvantage in that the method uses fixed templates and thus it is difficult to detect anchors in a variety of news programs.

The template-based method disclosed in the paper entitled “Template-based detection of anchor person shot in news programs” by A. Hanjalic in 1998 can be applied to various formats of news programs because templates are determined within news videos. However, the template-based method has a disadvantage in that information on the temporal positions of a first anchor shot used as a template should be generally known.

An example of the clustering-based method is disclosed in the paper entitled “A Graph-Theoretical Clustering based Anchor person Shot Detection for News Video Indexing” by Xinbo Gao in 2003. This method detects anchor shots by using a graph theory. However, the method has disadvantages in that only anchor shots appearing at least twice can be detected in news programs, and shots appearing in time intervals can be incorrectly detected. The conventional clustering-based methods disclosed in KR 2002-0075081, US 20020146168, and JP 2003-32583 cannot detect an anchor shot in news videos which are not suitable for a model of the anchor shot since the model of the anchor shot is determined in advance. In general, the clustering-based method has the disadvantage of a long detection time.

The multimodal-based method disclosed in KR 2002-0016318 extracts multimodal characteristics from news videos which includes closed caption signals, and automatically detects main sections of the news videos on the basis of the extracted characteristics to summarize the news.

In short, the disadvantages of the prior art are as follows.

Firstly, an incorrect detection may occur in shots, such as dialogue scenes other than typical news programs, because only information on colors of areas around an anchor's head is used (a problem of incorrectly detecting shots).

Secondly, when a format of a news program is changed, anchor shots cannot be detected when a fixed template is used(a problem of being unable to adapt to various formats of news programs).

Thirdly, anchor shots appearing only once cannot be detected throughout the entire news program (a problem of not detecting shots).

Fourth, a detection speed becomes low because clustering is performed by evaluating the amount of similarity between the entire key frames (a problem of a low speed).

### BRIEF SUMMARY

An aspect of the present invention provides a method of determining anchor shots capable of detecting anchor shots on various formats of videos, detecting shots rapidly, and detecting anchor shots that appear at least once in a program.

An aspect of the present invention also provides an apparatus for determining anchor shots capable of detecting anchor shots on various formats of videos, detecting shots rapidly, and detecting anchor shots that appears at least once in a program.

According to an aspect of the present invention, there is provided a method of determining anchor shots including: extracting a plurality of basic shots; selecting a plurality of anchor model candidate shots; determining at least one anchor model shot; and determining at least one anchor shot.

In the extracting operation, a plurality of basic shots may be extracted from video data according to a predetermined standard. In the selecting operation, a plurality of anchor model candidate shots may be selected from the plurality of basic shots by applying a first standard to the extracted plurality of basic shots. In the determining operation of the anchor model shot, at least one anchor model shot may be determined by applying a second standard to the plurality of anchor model candidate shots. The determining operation of the anchor shot, at least one anchor shot may be determined by comparing the similarity of at least one anchor model shot and the plurality of basic shots.

According to another aspect of the present invention, there is provided an apparatus for determining anchor shots including: a shot boundary determining unit; a skin color extracting unit; an anchor face determining unit; a background color area determining unit; an anchor model candidate shot determining unit; an object color area determining unit; a shot grouping unit; an anchor model creating unit; a block determining unit; and an anchor shot determining unit.

According to another embodiment of the present invention, there is provided an apparatus for determining anchor shots, including: an extracting section which extracts a plurality of basic shots from video data according to a predetermined standard; a selecting section which selects a plurality of anchor model candidate shots from the plurality of basic shots by applying a first standard to the plurality of basic shots; an anchor model shot determiner which determines at least one anchor model shot by applying a second standard to the plurality of anchor model candidate shots; and an anchor shot determiner which determines at least one anchor shot by comparing the-amount of similarity of the anchor model shots and the plurality of basic shots.

According to another embodiment of the present invention, there is provided a method of determining anchor shots, including: receiving video data to determine boundaries dividing shots, and extracting predetermined shots from the video data on the basis of the determined boundaries; extracting an anchor's skin from the extracted shots; determining the anchor's facial area using the information of the extracted skin color; distinguishing the anchor from a background by determining a color area for the background of the anchor; determining anchor model candidate shots among the extracted shots extracted using the determined anchor's facial area and the determined background color; determining information on genders of anchors, a number of anchors, and report shots by comparing amounts of similarity of colors of the anchors among the anchor model candidate shots; grouping together male anchor shots, female anchor shots, and report shots respectively using the determined information; creating anchor models according to positions of anchors in the groups of the male and female anchor shots; defining only a facial area and upper-half body of an anchor as one small block among the created anchor model shots; and determining at least one anchor shot among the male anchor shots and at least one anchor shot among the female anchor shots using the determined blocks.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a flowchart showing a method of determining anchor shots according to an embodiment of the present invention;

FIG. 2 is a diagram showing a cluster of anchor model candidate shots used in a method of determining anchor shots according to the embodiment of FIG. 1;

FIG. 3 is a diagram showing anchor model shots used in a method of determining anchor shots according to the embodiment of FIG. 1;

FIG. 4 is a diagram showing a method of dividing anchor model shots used in a method of determining anchor shots into blocks according to the embodiment of FIG. 1; and

FIG. 5 is a block diagram showing an apparatus for determining anchor shots according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

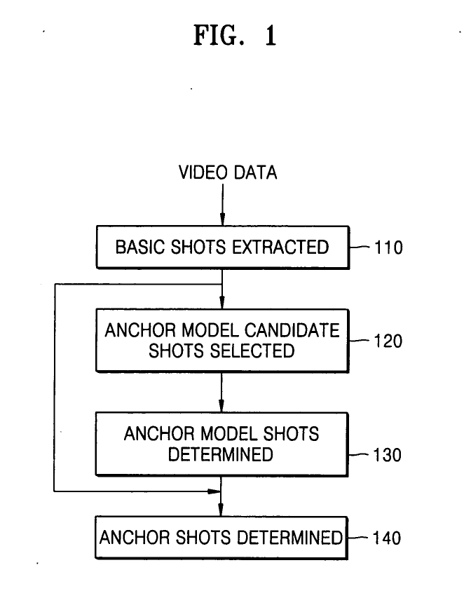

FIG. 1 is a flowchart showing a method of determining anchor shots according to an embodiment of the present invention.

The method of determining anchor shots includes a basic shot extracting operation 110, an anchor model candidate shot selecting operation 120, an anchor model shot determining operation 130, and an anchor shot determining operation 140.

The basic shot extracting operation 110 extracts a plurality of basic shots from a video of a news program or other programs on the basis of moment when an image displayed for a predetermined time is changed to a different image. Therefore, in the case of news videos, the plurality of basic shots include any data corresponding to the moment when an image is changed. Examples of such data include anchors, reporters, locations where events occurred, captions for summarizing events, and graphs.

The anchor model candidate shot selecting operation 120 selects a plurality of anchor model candidate shots from the plurality of basic shots by applying a first standard to the plurality of basic shots. The first standard is the amount of similarity of anchor face detection information, anchor face restriction condition, shot length, and background color information between the plurality of basic shots.

The anchor model shot determining operation 130 determines at least one anchor model shot by applying a second standard to the plurality of anchor model candidate shots. The second standard is the position and color information of the face and upper-half body of an anchor. The number of the anchor model shots is determined according to the gender of an anchor, and the position and color information of the face and upper-half body of the anchor.

The anchor shot determining operation 140 introduces a rectangle including the face and upper-half body of the anchor appearing on the anchor model shots and the basic shots, groups together pixels constituting the rectangle in order to divide the rectangle into a plurality of blocks, and determines shots having a close similarity regarding color information between the blocks constituting the compared shots to be anchor shots.

The method of detecting anchors will be now described in detail.

Firstly, the anchor model candidate shot selecting operation 120 is set forth.

The anchor model candidate shots are selected from all the basic shots in the news divided into shots by using a shot length, an anchor face restriction condition, an anchor face detection information, and background color information.

Information on the shot length is obtained under the assumption that at least one shot lasts for at least 10 seconds among shots on which the anchor appears in the news videos.

Since the anchor model candidate shots are images on which the faces of the anchors appear, it is possible to detect the faces of the anchors when skin colors are used as anchor face detection information. Colors having values between predetermined threshold values are determined to be the skin colors. The predetermined threshold values are set by a designer of the system.

If noise is removed from the data on the detected anchor face and an anchor face restriction condition is applied, more accurate data on the anchor face can be detected from the data on the detected anchor face, which is roughly obtained. The anchor face restriction condition is determined according to the size and the position of a face rectangle, varying degree, and skin color density.

The term “face rectangle” means a rectangle which includes a face by which a personal appearance is determined to be an anchor. If the entire screen on which an anchor appears is set as a basic shot, determining an anchor shot from shots including the anchor can be complicated. Therefore, it is preferable that the rectangle is defined as a minimum area which includes the face of an anchor, and the anchor shot is determined on the basis of data collected from the rectangle.

The position of a face rectangle means the position of an anchor on a screen. In general, the anchor is located in the center portion, the left side, or the right side of a screen.

The varying degree means a difference in an angle between the shots of the anchor's face that appears on a screen according to the angle of a camera, which records the anchor. Anchor shots having a small difference in an angle are considered to be the same shots.

The skin color density is also an important standard in the determination of the anchor face restriction condition. If shots having too low a skin color density are determined to be anchor shots, the screen may lack clarity. Therefore, the skin color density is a standard for removing the unclear shots.

In addition, the similarity of the background colors between the basic shots and the candidate shots is taken as a standard. Shots having a similarity equal to a threshold value or more are determined to be anchor model candidate shots. A normalized histogram intersection method is a means of measuring the similarity.

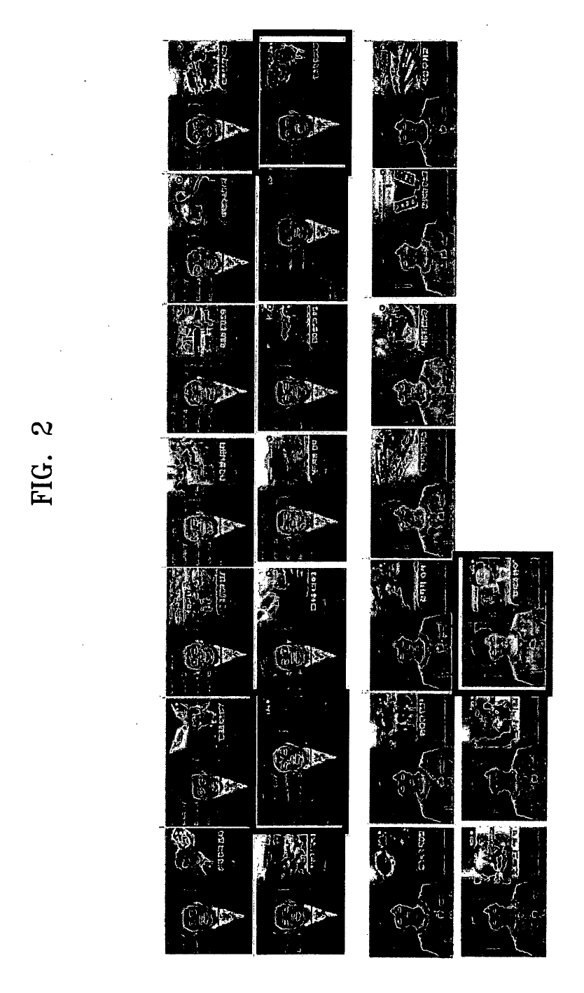

FIG. 2 shows a cluster of anchor model candidate shots used in a method to determine anchor shots according to the present embodiment. Shots satisfying the first standard are selected from the plurality of basic shots. Accordingly, the shots where appearances of male and female anchors are included are selected.

Secondly, the anchor model shot determining operation 130 is set forth.

The anchor model shots are selectively determined from the plurality of anchor model candidate shots selected through the above-mentioned method. For the determination of the anchor model shots, similar shots are clustered by collecting data on the colors of the face and upper-half body of an anchor.

After a rectangle including the facial area is removed from a first anchor model candidate shots, the skin color distribution of each of the YCbCr colors of the rectangle including the upper-half body area is analyzed for each shot. A male anchor typically wears suits and a female anchor typically wears single-colored clothes. Therefore, the color information of an anchor object, which is obtained from the above method, is reliable. The colors of the upper-half body of an anchor can be extracted by use of the color information on the anchor object. In order to create the upper-half body candidate rectangle, the facial area of the extracted anchor model candidate is enlarged to the right, left, bottom, and upper directions, respectively.

Then, the anchor upper-half body portion can be detected from the upper-half body area of the candidate rectangle by using the color information which is inspected in advance. Anchor objects can be obtained by performing an OR operation of the facial and upper-half body areas. The anchor objects constitute a histogram for each of the YCbCr colors. However, since the obtained anchor objects are not consistent in size in news videos, the anchor objects are normalized to have values from 0 to 1 by dividing by the size of one of the anchor objects.

A histogram indicates relative weights of colors in a shot. The present embodiment obtains the histogram for a rectangle including the facial area rather than for the entire shot.

Equation 1 represents a histogram which is a standard of clustering.
Reference_Object_Histogram:O_{R}_{_{iε{Y,Cb,Cr}}} [Equation 1]

Here, since “i” denotes the variable for the three colors Y, Cb, and Cr, Equation 1 means that the histogram is made for the three colors Y, Cb, and Cr. “O (Object)” is used as the denotation of a function in order to emphasize that the histogram is for a specific object rather than for the entire screen.

Like the histogram for the anchor object, a histogram for each of YCbCr colors is represented as Equation 2.
Candidate_Object_Histogram:O_{C}_{_{iε{Y,Cb,Cr}}} [Equation 2]

Clustering is performed by measuring the amount of similarity between the standard histogram and the candidate histogram. The conventional normalized histogram intersection method is used for evaluating the similarity.

The similarity can be obtained by Equation 3.

$$H ( {O}_{R} , {O}_{C} ) = {\sum }_{i = 1}^{n} min ( {O}_{Ri} , {O}_{Ci} ) \qquad [ Equation 3 ]$$

where “O_{R}” denotes a standard histogram, “O_{C}” denotes a candidate histogram, and “n” denotes the number of blocks. Since the anchor object colors of anchor shots are very similar, shots having an amount of similarity equal to a predetermined threshold value or more are considered as shots belonging to the same cluster.

When clustering is performed using the amount of similarity of colors, the shots can be divided into male anchor shots, female anchor shots, and report shot groups. To make a model of an anchor, an anchor model group may be selected among a cluster having a number of shots.

Among the selected cluster, the anchor model is made using the information on the position of each anchor's face. The anchor's face is located at the left side, the center portion, or the right side of a screen. When the anchor's face is positioned on the left side of the screen, a news icon or title indicating the contents of the news is displayed on the right side of the screen. On the contrary, when the anchor's face is positioned on the right side of the screen, a news icon or title indicating the contents of the news is displayed on the left. Therefore, when the anchor appears on the left or the right side of the screen, the remaining portions, such as a news icon or title, are removed. When the anchor's face is positioned in the center of the screen, a news icon or title is not displayed on the screen.

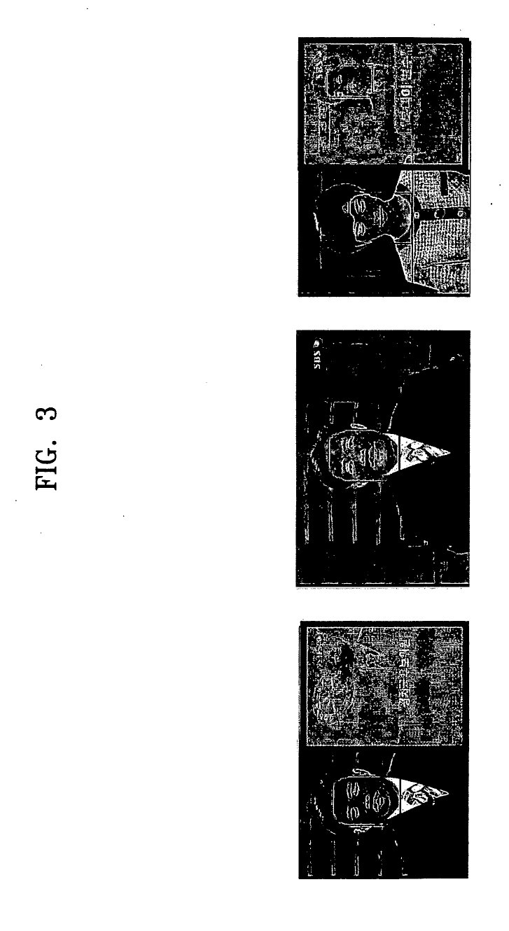

FIG. 3 shows anchor model shots used in a method to determine anchor shots according to the present embodiment.

Shots satisfying the second standard are selected among anchor model candidate shots shown in FIG. 2. FIG. 3 shows three selected anchor model shots. In case of a male anchor, shots in which the male anchor appears on the left and the center of the screen are determined to be the anchor model shots. In case of a female anchor, a shot in which the female anchor appears only on the left is determined to be the anchor model shot. The anchor model shots are determined by a pool of the anchor model candidate shots shown in FIG. 2.

Thirdly, the anchor shot determining operation 140 is set forth.

The amount of similarity is measured between the created anchor models and the basic shots. Shots having the similarity of a predetermined value or more are determined to be anchor shots.

For a comparison of the similarity, a rectangle having the same position and size as the model is divided into a plurality of blocks, e.g., 24 blocks.

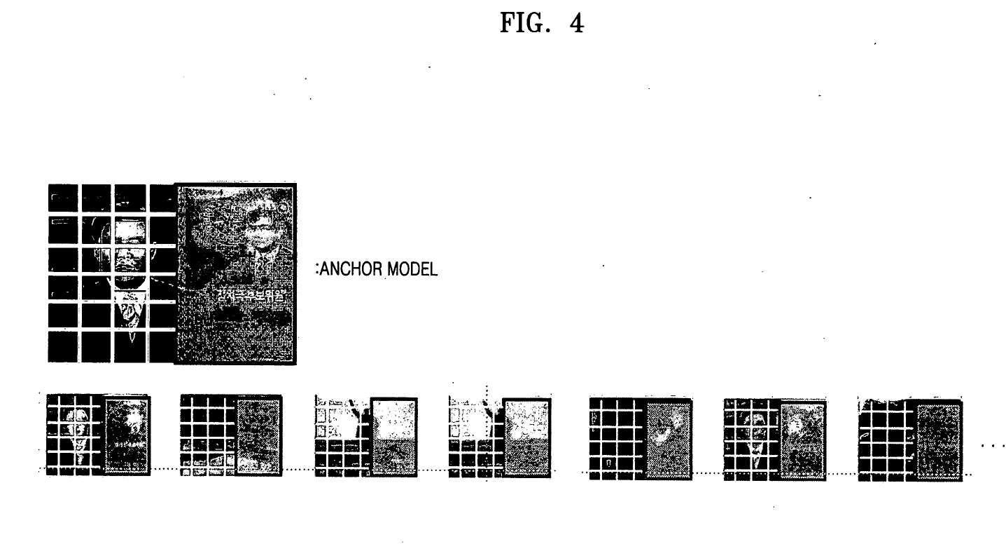

FIG. 4 is a diagram showing a method of dividing anchor model shots used in a method of determining anchor shots into blocks according to the present embodiment.

Anchor model shots divided into a plurality of blocks and basic shots are shown in FIG. 4. In the method of dividing the anchor model shots into blocks, a caption on the right of a screen is not considered when an anchor appears on the left side of the screen. In other words, only the anchor on the left side of the screen is divided into a plurality of blocks. The divided plurality of block data are considered as key data and compared with basic shots. Also in the basic shots compared, only the left side of the screen is considered.

The anchor is positioned in almost an identical position in the anchor shots of the news. However, considering that the camera and the anchor slightly move, the amount of similarity of the block that has the position information should be used as a standard in order to obtain a reliable result.

The mean value B_{K} for a predetermined K block is represented as Equation 4.

$${B}_{K} = \frac{{\sum }_{i = 1}^{N} {RGB}_{K} ( i )}{N} \qquad [ Equation 4 ]$$

Here, a symbol RGB_{K}(i) denotes a corresponding value to color of the block K, and a symbol N denotes the number of pixels in a single block.

A difference “Differ” between the mean value B_{KA} for the anchor model block K and the mean value B_{KS} for the key frame block K is represented as Equation 5.

$$Differ = {\sum }_{K = 1}^{G} \vert {B}_{KA} - {B}_{KS} \vert \qquad [ Equation 5 ]$$

Here, a symbol G denotes the number of the entire blocks included in a screen. When the difference is a predetermined threshold value or more, the shot is determined to be the anchor shot.

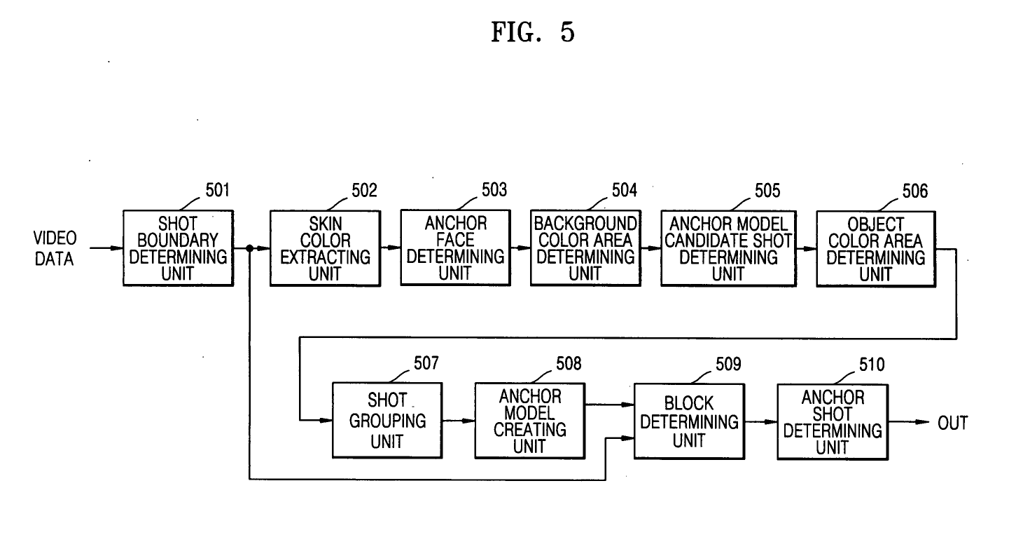

FIG. 5 is a block diagram showing an apparatus for determining anchor shots according to an embodiment of the present invention.

The apparatus for determining anchor shots includes a shot boundary determining unit 501, a skin color extracting unit 502, an anchor face determining unit 503, a background color area determining unit 504, an anchor model candidate shot determining unit 505, an object color area determining unit 506, a shot grouping unit 507, an anchor model creating unit 508, a block determining unit 509, and an anchor shot determining unit 510.

The shot boundary determining unit 501 receives video data to determine boundaries which divides shots, and extracts predetermined shots from the video data on the basis of the determined boundaries.

The skin color extracting unit 502 extracts the color of the anchor's skin in the shots extracted from the shot boundary determining unit 501.

The anchor face determining unit 503 determines the anchor's face by using information on the skin color extracted from the skin color extracting unit 502.

The background color area determining unit 504 makes it possible to distinguish the anchor from the background by determining a color area for the background of the anchor determined in the anchor face determining unit 503.

The anchor model candidate shot determining unit 505 determines anchor model candidate shots among the shots extracted in the shot boundary determining unit 501 by using information on the anchor determined in the anchor face determining unit 503 and the background color determined in the background color area determining unit 504.

The object color area determining unit 506 determines the gender of the anchors, the number of anchors, and report shots by comparing similarity of colors of anchors among the shots determined in the anchor model candidate shot determining unit 505.

The shot grouping unit 507 groups together male anchor shots, female anchor shots, and report shots respectively by using the information determined in the object color area determining unit 506.

The anchor model creating unit 508 creates anchor models according to positions of anchors in the groups of the male and female anchor shots created in the shot grouping unit 507. In other words, the anchor model shots are created depending on whether anchors are located at the left side, the center portion, or the right side of a screen.

The block determining unit 509 defines only the facial area and upper-half body of an anchor as one small block among the anchor model shots created in the anchor model creating unit 508. The remaining area is excluded from the block.

The anchor shot determining unit 510 determines at least one anchor shot among the male anchor shots and at least one anchor shot among the female anchor shots created in the anchor model creating unit 508 by using the blocks determined in the block determining unit 509.

According to the disclosed embodiment of the present invention, the method of determining the anchor shots adaptively creates and utilizes the left side, the right side, and the center portion models of the anchor in news videos in order to detect anchor shots from various formats of news videos. In order to prevent the incorrect detection and increase the detection speed, the similarity is compared for the same position and size between the entire key frames and the created anchor models. In order to detect the shots for anchors appearing at least once, the key frames similar to anchor models are detected as the anchor shots.

It is be understood from the detailed description that the method of detecting the anchor by using the model creation can be adapted not only to news videos but also to all video data, as typical video data, which should be provided with indexing and browsing functions.

For instance, videos for English conversation instruction include a plurality of dialogues according to typically established situations. In general, the plurality of dialogues develop after briefing of a master of ceremonies (MC) about the situations to be developed next. Therefore, the plurality of dialogues can be classified on the basis of the MC's appearance.

It is to be understood that a figure corresponding to a news anchor is the MC of the video data for English conversation instruction. Therefore, it is to be understood that the disclosed embodiment of the present invention can be adapted to video data for English conversation instruction as well as news videos. It is to be understood that the anchor means not only a news announcer but also any standard used for classifying video data.

According to the disclosed embodiment of the present invention, it is possible to provide a method of determining anchor shots and an apparatus therefor using the model creation capable of detecting anchor shots for various formats of videos by creating adaptive anchor models rather than by using a predetermined model, and improving its speed and performance by comparing the similarity of the created models and the entire key frames. Therefore, the disclosed embodiment of the present invention can be used in indexing, summarizing, and browsing based on a household AV device, an authoring tool for providing contents, and contents of news videos.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of determining anchor shots which can be used in indexing, summarizing, and browsing contents of video data, comprising:
extracting a plurality of basic shots from the video data according to a predetermined standard;
selecting a plurality of anchor model candidate shots from the plurality of basic shots by applying a first standard to the plurality of basic shots;
determining at least one anchor model shot by applying a second standard to the plurality of anchor model candidate shots; and
determining at least one anchor shot by comparing the amount of similarity of the anchor model shots and the plurality of basic shots.

2. The method of claim 1, wherein the predetermined standard is a condition when a screen halted for a predetermined time changes to another screen.

3. The method of claim 1, wherein the first standard is an amount of similarity of anchor face detection information, an anchor face restriction condition, a shot length, and background color information.

4. The method of claim 3, wherein the anchor face restriction condition is determined according to a size and a position of a facial rectangle area, skin color density, and a movement of the facial rectangle area.

5. The method of claim 4, wherein the facial rectangle is a rectangle which includes a face and by which a personal appearance can be determined to be an anchor.

6. The method of claim 5, wherein the facial rectangle is defined as a minimum area which includes the face of the anchor.

7. The method of claim 4, wherein the anchor face restriction condition is determined according to a varying degree which is a difference in angle between shots of an anchor's face.

8. The method of claim 4, wherein the skin color density is used to remove unclear shots.

9. The method of claim 3, wherein the background color information is obtained on the basis of a rectangle including a face.

10. The method of claim 9, wherein the background color information is a normalized and quantized color histogram which is obtained on the basis of a rectangle including the face.

11. The method of claim 9, wherein the dimensions of the rectangle depend on whether a facial area is located at a left side, a right side, or a center portion of a screen, and wherein the rectangle indicates a minimum area of the left side or the right side of a screen including the facial area and upper-half body when the facial area is located at the left side or the right side of the screen, and the rectangle indicates an entire area of the screen when the facial area and upper-half body is located in the center portion.

12. The method of claim 11, wherein the rectangle is divided into a plurality of blocks by grouping a plurality of pixels of the rectangle.

13. The method of claim 1, wherein the second standard is a position and color information of a facial area and upper-half body of an anchor on a screen, and wherein the number of the anchor model shots is determined according to a gender of an anchor and a position of the face and upper-half body of the anchor.

14. The method of claim 1, wherein the determining at least one anchor shot includes:
introducing a rectangle including a face and upper-half body of an anchor appearing on the anchor model shots and the plurality of basic shots;
grouping together a plurality of pixels of the rectangle to divide the rectangle into a plurality of blocks; and
comparing amounts of similarity of color information between the blocks of the compared shots.

15. The method of claim 10, wherein the color information is a color histogram that normalizes and quantizes color information of the facial area and upper-half body.

16. The method of claim 1, wherein, in the determining of the at least one anchor model shot, the anchor model shots are determined among a number of anchor model candidate shots.

17. The method of claim 16, wherein, in the determining of the at least one anchor model shot, the number of the anchor model shots is determined according to a gender of an anchor and a position of the facial area and upper-half body of an anchor appearing on a screen from among the anchor model candidate shots.

18. The method of claim 1, wherein the extracting extracts the plurality of basic shots from a video of a program on the basis of moment when an image displayed for a predetermined time is changed to a different image.

19. The method of claim 18, wherein the plurality of basic shots include data corresponding to a time when an image is changed.

20. The method of claim 19, wherein the data includes anchors, reporters, locations where events occurred, captions for summarizing events, and graphs.

21. The method of claim 1, wherein, in the determining at least one anchor model shot, similar shots are clustered by collecting data on colors of a face and upper-half body of an anchor.

22. The method of claim 21, wherein the clustering includes determining relative weights of colors in a shot.

23. The method of claim 22, wherein the relative weights are measured by comparing a reference object histogram to a candidate object histogram, the reference object histogram represented by the following equation:
Reference_Object Histogram:O_{R}_{_{iε{Y,Cb,Cr}}},
wherein “i” denotes the variable for three colors Y, Cb, and Cr, and when the histogram for each of colors YCbCr is represented by the following equation:
Candidate_Object_Histogram:O_{C}_{_{iε{Y,Cb,Cr}}}.

24. The method of claim 23, wherein the clustering is performed by measuring an amount of similarity between a reference histogram and a candidate histogram.

25. The method of claim 24, wherein the amount of similarity is determined by the following equation:
$$H ( {O}_{R} , {O}_{C} ) = {\sum }_{i = 1}^{n} min ( {O}_{Ri} , {O}_{Ci} ) ,$$
wherein “O_{R}” denotes a standard histogram, “O_{C}” denotes a candidate histogram, and “n” denotes a number of blocks.

26. An apparatus for determining anchor shots which can be used in indexing, summarizing, and browsing contents of video data, comprising:
a shot boundary determining unit receiving video data to determine boundaries dividing shots, and extracting predetermined shots from the video data on the basis of the determined boundaries;
a skin color extracting unit extracting an anchor's skin from the shots extracted by the shot boundary determining unit;
an anchor face determining unit determining the anchor's facial area using the information of the skin color extracted by the skin color extracting unit;
a background color area determining unit distinguishing the anchor from a background by determining a color area for the background of the anchor;
an anchor model candidate shot determining unit determining anchor model candidate shots among the shots extracted by the shot boundary determining unit using information on the anchor determined by the anchor face determining unit and the background color determined by the background color area determining unit;
an object color area determining unit determining information on genders of anchors, a number of anchors, and report shots by comparing amounts of similarity of colors of the anchors among the shots determined by the anchor model candidate shot determining unit;
a shot grouping unit grouping together male anchor shots, female anchor shots, and report shots respectively using the information determined by the object color area determining unit;
an anchor model creating unit creating anchor models according to positions of anchors in the groups of the male and female anchor shots created by the shot grouping unit;
a block determining unit defining only a facial area and upper-half body of an anchor as one small block among the anchor model shots created by the anchor model creating unit; and
an anchor shot determining unit determining at least one anchor shot among the male anchor shots and at least one anchor shot among the female anchor shots created by the anchor model creating unit using the blocks determined by the block determining unit.

27. An apparatus for determining anchor shots, comprising:
an extracting section which extracts a plurality of basic shots from video data according to a predetermined standard;
a selecting section which selects a plurality of anchor model candidate shots from the plurality of basic shots by applying a first standard to the plurality of basic shots;
an anchor model shot determiner which determines at least one anchor model shot by applying a second standard to the plurality of anchor model candidate shots; and
an anchor shot determiner which determines at least one anchor shot by comparing the amount of similarity of the anchor model shots and the plurality of basic shots.

28. A method of determining anchor shots, comprising:
receiving video data to determine boundaries dividing shots, and extracting predetermined shots from the video data on the basis of the determined boundaries;
extracting an anchor's skin from the extracted shots;
determining the anchor's facial area using the information of the extracted skin color;
distinguishing the anchor from a background by determining a color area for the background of the anchor;
determining anchor model candidate shots among the extracted shots extracted using the determined anchor's facial area and the determined background color;
determining information on genders of anchors, a number of anchors, and report shots by comparing amounts of similarity of colors of the anchors among the anchor model candidate shots; grouping together male anchor shots, female anchor shots, and report shots respectively using the determined information;
creating anchor models according to positions of anchors in the groups of the male and female anchor shots;
defining only a facial area and upper-half body of an anchor as one small block among the created anchor model shots; and
determining at least one anchor shot among the male anchor shots and at least one anchor shot among the female anchor shots using the determined blocks.
